(19) United States
(12) Patent Application Publication
(10) Pub. No.: US 2026/0056935 A1
(43) Pub. Date: Feb. 26, 2026

(54) COMPUTER SYSTEMS, METHODS, AND NON-TRANSITORY COMPUTER-READABLE STORAGE DEVICES FOR TRUST ANALYSIS OF ONLINE MEDIA

(71) Applicant: Royal Bank of Canada, Toronto (CA)

(72) Inventors: Meron MEHARI, Toronto (CA); Wenqing LIU, Vancouver (CA); Kyler WITVOET, Hamilton (CA); Amanveer SINGH, Brampton (CA); Issar Amit KANIGSBERG, Toronto (ON)

(21) Appl. No.: 19/305,060

(22) Filed: Aug. 20, 2025

Related U.S. Application Data
(60) Provisional application No. 63/685,630, filed on Aug. 21, 2024.

(51) Int. Cl. G06F 16/23; G06F 9/54

(52) U.S. Cl. CPC G06F 16/2365; G06F 9/547

(57) ABSTRACT

Computer systems, methods, and non-transitory computer-readable storage devices for trust analysis and content reliability of online media are disclosed. A computerized method comprises: receiving an article that a user is viewing on a user device; analyzing the article to determine one or more trust factors related to the article; determining a content reliability score of the article using a contextually-trained trust analysis artificial intelligence (AI) model based on the one or more trust factors; and outputting the content reliability score of the article for display in a user interface of the user device.

### CROSS-REFERENCE TO RELATED APPLICATIONS

This application claims priority to U.S. Provisional Patent Application No. 63/685,630, filed on Aug. 21, 2024, the entire contents of which is hereby incorporated by reference herein for all purposes.

### TECHNICAL FIELD

The present disclosure relates generally to computer systems, methods, and non-transitory computer-readable storage devices, and in particular to computer systems, methods, and non-transitory computer-readable storage devices for trust analysis and content reliability of online media.

### BACKGROUND

Online media such as online language-based media is often mixed with true, biased, or false statements, news, stories, articles, and/or the like. Currently, trust analysis of online media mainly relies on human effort, which may cause heavy burden to readers, may be generally slow, and may not lead to reliable results.

In prior art, GROUND News only focuses on political bias and not misinformation, GROUND combines manual reviews of News organizations to determine if the organization itself has a reputation of being factual or not and left, right, center.

Most existing solutions rely on manual analysis and do not integrate directly into the browser. Moreover, existing solutions usually do not refer to trusted sources, and do not simultaneously combine various multiple factors or dimensions such as community feedback/reviews, trusted sources, or extracting features from the text of the article.

### SUMMARY

According to one aspect of this disclosure, there is provided a computerized method comprising: obtaining an article that a user is viewing on a user device; analyzing the article to determine one or more trust factors related to the article; determining a content reliability score of the article using a contextually-trained trust analysis artificial intelligence (AI) model based on the one or more trust factors; and outputting the content reliability score of the article for display in a user interface of the user device.

In some aspects, the user is viewing the article in a web browser on the user device, wherein an application programming interface (API) obtains the article via a web browser extension running on the user device, and wherein the content reliability score is output from the API to the web browser extension that displays the content reliability score in the web browser.

In some aspects, the one or more trust factors related to the article comprise one or more of: an indication of whether any facts claimed in the article disagree with trusted sources; an amount of emotional and/or sensational words used in the article; a readability level of the article; a number of sources cited in the article; and an amount of user reviews in favour or against the reliability of the article.

In some aspects, the indication of whether any facts claimed in the article disagree with trusted sources is determined by: using one or more AI models to determine a topic of the article; using the one or more AI models to determine facts claimed in the article; determining one or more relevant articles from one or more trusted sources based on the topic of the article; and comparing the facts claimed in the article with facts claimed in the one or more relevant articles to determine whether any facts claimed in the article disagree with the trusted sources.

In some aspects, the method further comprises generating a vector database comprising facts claimed in articles from the one or more trusted sources, and wherein the vector database is accessed for comparing the facts claimed in the article with the facts claimed in the one or more relevant articles.

In some aspects, the amount of emotional and/or sensational words used in the article is determined by classifying each word in the article using an emotional lexicon, and calculating a percentage of positive, negative, and/or emotional language in the article;

In some aspects, the readability level of the article is determined using a further AI model.

In some aspects, the user reviews are received via the user interface.

In some aspects, the method further comprises outputting information related to the one or more trust factors in the user interface.

In some aspects, the method further comprises receiving a user review of the reliability of the article via the user interface from the user viewing the article, and performing continuous model training and/or augmentation based on the user review . . .

According to another aspect of this disclosure, there is provided a system comprising one or more processors; and one or more non-transitory computer-readable storage media functionally coupled to the one or more processors; wherein the one or more non-transitory computer-readable storage media comprise computer-executable instructions, which., when executed, cause the system to perform the computerized method in accordance with any one of the above aspects.

According to another aspect of this disclosure, there is provided one or more non-transitory computer-readable storage devices comprising computer-executable instructions, which, when executed, cause one or more processing units to perform the computerized method in accordance with any one of the above aspects.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a computer network system according to some embodiments of this disclosure;

FIG. 2 is a block diagram of a server of the computer network system shown in FIG. 1;

FIGS. 3A-D are schematic diagrams showing a functional architecture of the computer network system shown in FIG. 1, according to some embodiments of this disclosure;

FIGS. 4A and 4B are flowcharts showing a trusted sources semantic search method performed by the computer network system shown in FIG. 1, according to some embodiments of this disclosure;

FIGS. 5A and 5B are flowcharts showing an intermediate model training method performed by the computer network system shown in FIG. 1, according to some embodiments of this disclosure;

FIG. 6 is a flowchart showing a model inference method performed by the computer network system shown in FIG. 1, according to some embodiments of this disclosure;

FIG. 7 is a flowchart showing a user feedback collection method performed by the computer network system shown in FIG. 1, according to some embodiments of this disclosure

FIGS. 8A and 8B are flowcharts showing an automatic fact check method performed by the computer network system shown in FIG. 1, according to some embodiments of this disclosure;

FIGS. 9A and 9B are flowcharts showing a manual fact check method performed by the computer network system shown in FIG. 1, according to some embodiments of this disclosure;

FIG. 10 shows a user flow diagram for the computer network system shown in FIG. 1, according to some embodiments of this disclosure;

FIGS. 11A to 11G are sample user interfaces (UIs) a user may experience when the computer network system shown in FIG. 1 performs trust analysis, according to some embodiments of this disclosure; and

FIG. 12 shows a computerized method for performing trust analysis of online media, according to embodiments of this disclosure.

### DETAILED DESCRIPTION

Embodiments disclosed herein relate to a computer network system and related software applications such as web applications for trust analysis of online media, such as online language-based media, by combining multiple dimensions or factors of trust to evaluate a reliability of content in online media.

Computer systems, methods, and non-transitory computer-readable storage devices for trust analysis of online media are disclosed. In at least some aspects, a computerized method comprises: receiving an article that a user is viewing on a user device; analyzing the article to determine one or more trust factors related to the article; determining a content reliability score of the article using a contextually-trained trust analysis artificial intelligence (AI) model based on the one or more trust factors; and outputting the content reliability score of the article for display in a user interface of the user device.

In some embodiments, the computer network system provides a multi-level and multi-factor software framework for trust analysis of online media as an application programming interface (API) and browser plug-in. The multiple levels allow for a user's increasingly in-depth understanding of an article's trust factors, for example:

Single and initial point of trustability/reliability awareness.

Brief outline of primary trust factors contributing to the initial point.

Deep dive and assessment tools including:
a. Set of trust factors,
b. Claim/fact validation,
c. Comparison to other articles in story/topic.

View of overview of all articles clustered in a story/topic.

In some embodiments, an API that processes a given article is provided, which evaluates whether users should be cautious when consuming the information of the article, provides articles and opinions from trusted sources on the same topic, and allows users to report false claims or untrustworthy content.

In some embodiments, a browser extension such as a Google Chrome extension is provided, which connects to the API and provides the information gathered from the API directly to the user in their browsing workflow, wherein the gathered information may comprise: content reliability score and insights into the reliability, relevant articles and opinions, reviews from other employees if they exist, and/or the like.

In various embodiments, the computer network system and the trust analysis methods disclosed herein provide a variety of features such as:

Summarizing the article, including for example:
identifying key points and truth claims.
extracting companies, sectors, authors, and/or the like discussed in the article and author of the article.

Gathering and providing relevant articles and/or opinions from one or more trusted sources, including for example:
when adding an article to the vector database, also adding the companies, sectors, authors, and/or the like as “metadata” which can be used to filter results.
semantic search on articles from the trusted sources in an insight portal;
collecting thought-leader's opinions;
collecting articles from the web and establishes story/topic clusters, allowing for users to quickly see “the whole picture” of a story.

Assessing trust factors and content reliability metrics, including for example:
identifying emotional and sensational words;
identifying readability level;
calculating a trust metric/content reliability score using a machine learning (ML) model trained on data collected from previous websites;
ability to select claims in an article to validate against trusted sources;
identifying which reliability metrics are most divergent from a story/topic cluster.

Collecting user feedback, including for example:
collecting article traffic;
allowing users to provide a rating and/or comment on the article's reliability, which may be used for data labeling and future model training;
prompting users with a question such as: “Do you find this content reliable?”: yes or no; if no, why?

The computer network system and the trust analysis methods disclosed herein thus advantageously provide an automated trust analysis process for evaluating online media. In some embodiments, the computer network system and the trust analysis methods disclosed herein may provide links to relevant articles from trusted sources as a benchmark for claim validation.

In some embodiments, the computer network system and the trust analysis methods disclosed herein integrate multiple dimensions of trust allowing for a full spectrum view and more robust trust assessment.

In some embodiments, the computer network system and the trust analysis methods use trained ML models to detect if content in a given article is questionable or safe (i.e. unreliable or reliable).

In some embodiments, the computer network system and the trust analysis methods prompt users to take caution when an article is questionable or unreliable.

In some embodiments, the computer network system and the trust analysis methods incorporate user feedback and media aggregation for continuous model training and augmentation.

In some embodiments, the computer network system and the trust analysis methods may be integrated into various systems and user interface (UI) plug-ins.

In some embodiments, the computer network system and the trust analysis methods cluster stories and/or topics thereby allowing for article and author comparisons both for claim validation and providing alternate perspectives to users.

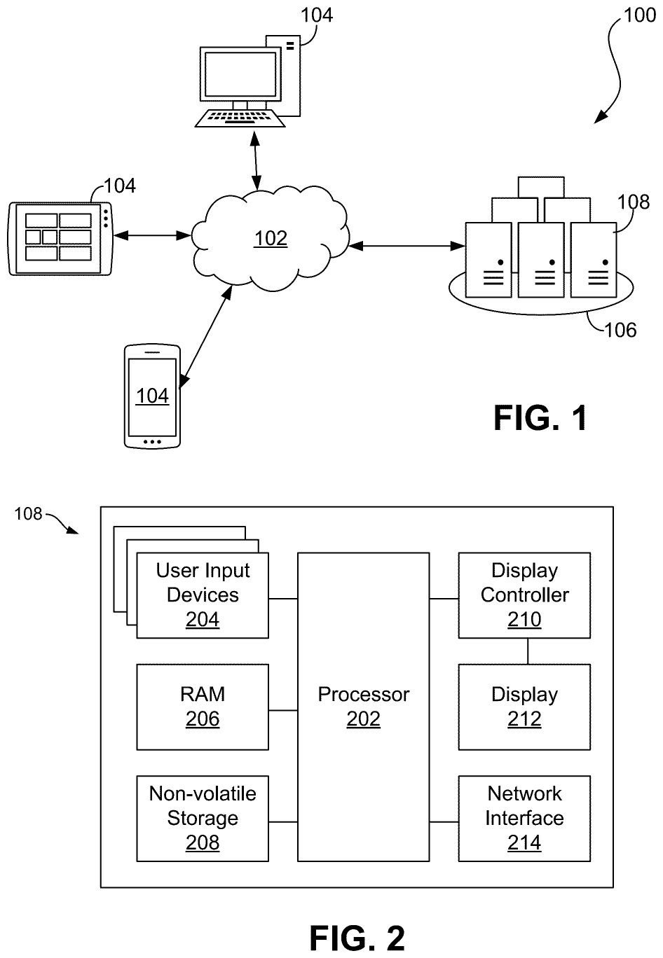

Referring now to FIG. 1, there is shown a computer network system 100 that comprises an example embodiment of a computerized trust analysis system. Herein, a “user” refers to a user of the computer network system 100.

As shown in FIG. 1, the computer network system 100 comprises a network 102 such as a local area network (LAN), a metropolitan area network (MAN), a wide area network 102 (WAN; for example, the Internet) and/or the like, to which various user devices 104, and data center 106 are communicatively coupled via suitable wired and/or wireless networking connections, such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 4G, 5G, 6G, and/or other mobile communication networks, and/or the like. In some embodiments, parallel ports, serial ports, USB connections, optical connections, or the like may also be used for connecting other computing devices or networks although they are usually considered as input/output interfaces for connecting input/output devices.

The data center 106 comprises one or more servers 108 networked together to collectively perform various computing functions. For example, in the context of a financial institution such as a bank, the data center 106 may host online banking services that permit users to log in to servers 108 thereof using user accounts that give them access to various computer-implemented services, and the users of user devices 104 may also visit various webpages, such as to view online media including news, stories, articles, and/or the like (referred to generally herein as articles).

As described above, it will be appreciated that articles in online media may contain false, biased, and/or unreliable content. In accordance with the present disclosure, computer systems, methods, and non-transitory computer-readable storage devices for trust analysis of online media are disclosed. A trust analysis method for determining a content reliability of an article being viewed at a user device can be implemented and the results output to the user, so that a user may use caution when consuming content from the article, and/or to allow a user to compare claims made in the article to claims made from trusted sources. In some embodiments, the trust analysis method may be performed by the one or more servers 108 in communication with user devices 104 when a user of a user device is viewing an article thereon. The user device 104 and the one or more servers 108 may be conveniently in communication via a web browser extension and API. As an example, the article may be obtained at an application programming interface (API) of the server(s) 108 via the web browser extension running on the user device, the one or more server(s) determine a content reliability score of the article, and the content reliability score is output from the server(s) 108 via the API to the web browser extension that displays the content reliability score in the web browser of user device. It will also be appreciated, however, that the user devices 104 themselves may have stored thereon and execute instructions/software for implementing the trust analysis method disclosed herein.

Referring now to FIG. 2, there is depicted an example embodiment of one of the servers 108 of the data center 106. The server 108 comprises one or more processors 202 that control the server's overall operation. The one or more processors 202 are communicatively coupled to and control several subsystems. These subsystems comprise one or more user input devices 204, which may comprise, for example, any one or more of a keyboard, mouse, touch screen, voice control, and/or the like; one or more non-transitory computer-readable storage devices or media 206 such as random access memory (“RAM”), which store computer-executable instructions or program code for execution at runtime by the processor 202; non-transitory, non-volatile, computer-readable storage devices or media 208, which store the computer-executable instructions or program code executed by the RAM 206 at runtime; a display controller 210, which is communicatively coupled to and controls a display 212; and a network interface 214, which facilitates network communications with the wide area network 102 and the other servers 108 in the data center 106. The non-volatile storage 208 has stored thereon computer program code that is loaded into the RAM 206 at runtime and that is executable by the processor 202. When the computer program code is executed by the processor 202, the processor 202 causes the server 108 to implement the method disclosed herein (described in more detail below). Additionally or alternatively, the servers 108 may collectively perform that method using distributed computing. While the system depicted in FIG. 2 is described specifically in respect of one of the servers 108, analogous versions of the system may also be used for the user devices 104.

The processor 202 used in the foregoing embodiments may comprise, for example, a processing unit (such as one or more processors, microprocessors, or programmable logic controllers) or one or more microcontrollers (which comprise both one or more processing units and one or more non-transitory computer readable media). Examples of processors include INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like.

Examples of computer readable media that are non-transitory include disc-based media such as CD-ROMs and DVDs, magnetic media such as hard drives and other forms of magnetic disk storage, semiconductor-based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

Generally, each processor 202 comprises necessary circuitries implemented using technologies such as electrical and/or optical hardware components for executing one or more processes as the implementation purpose and/or the use case maybe, to perform various tasks. In many embodiments, the one or more processes may be implemented as firmware and/or software stored in the RAM 206 and/or the storage 208. Those skilled in the art will appreciate that, in these embodiments, the one or more processors 202 and the user computing devices 104 and/or servers 108 are usually of no use without meaningful firmware and/or software. On the other hand, a user computing device 104 and/or server 108 is practically useful only when it has a suitable software program to execute for performing a practical task. Therefore, the functionalities and uses of a computing device are not only determined by its hardware (which may, for example, make the computing device more “powerful”), but also determined by its software (which may, for example, make the computing device more efficient and useful in more practical areas). Therefore, hardware and software are generally integrated parts of a user computing device 104 and/or server 108.

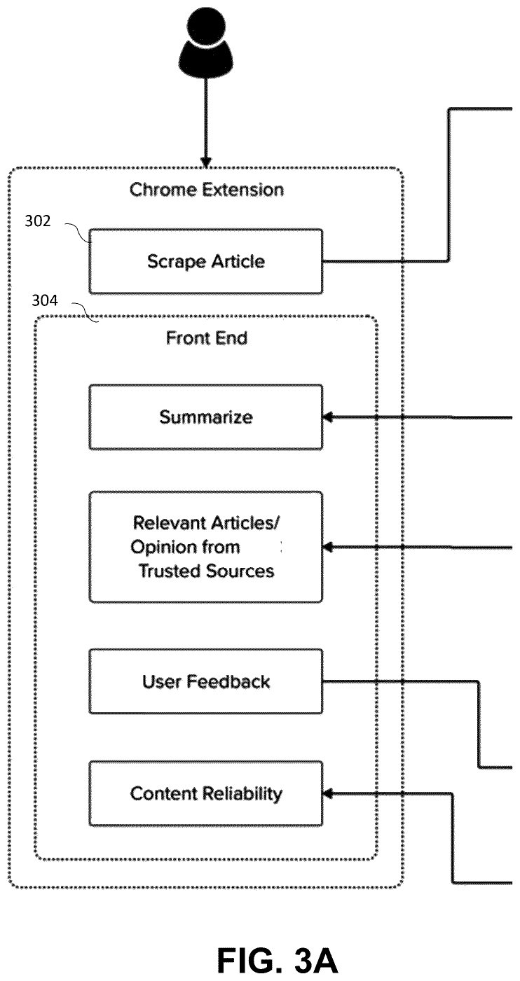

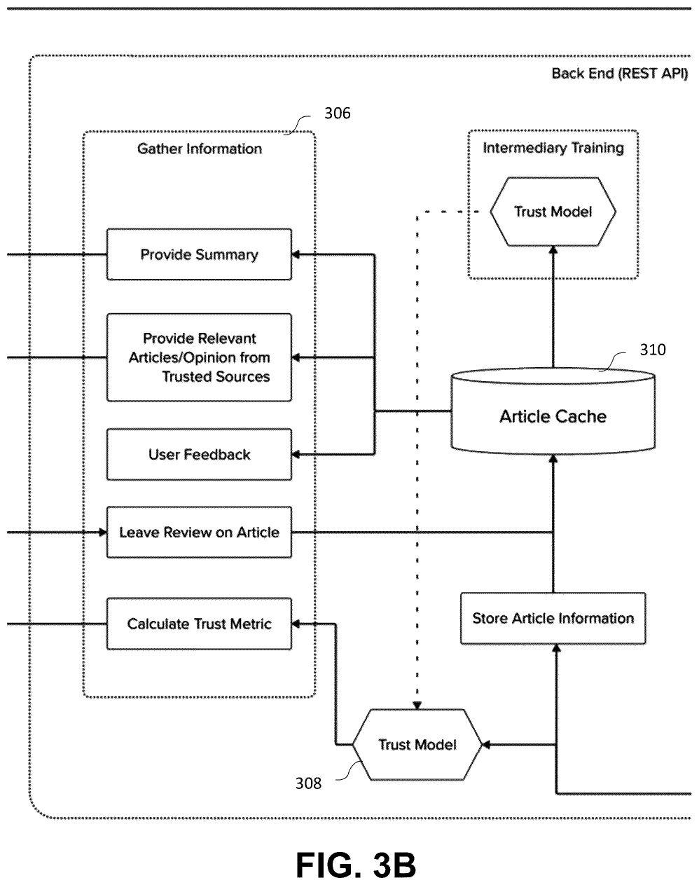

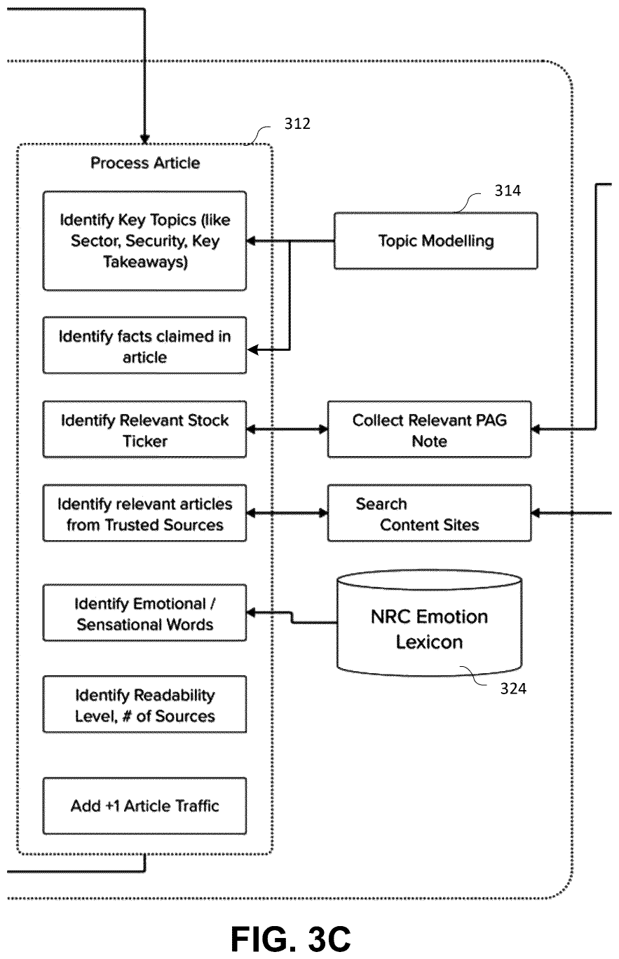

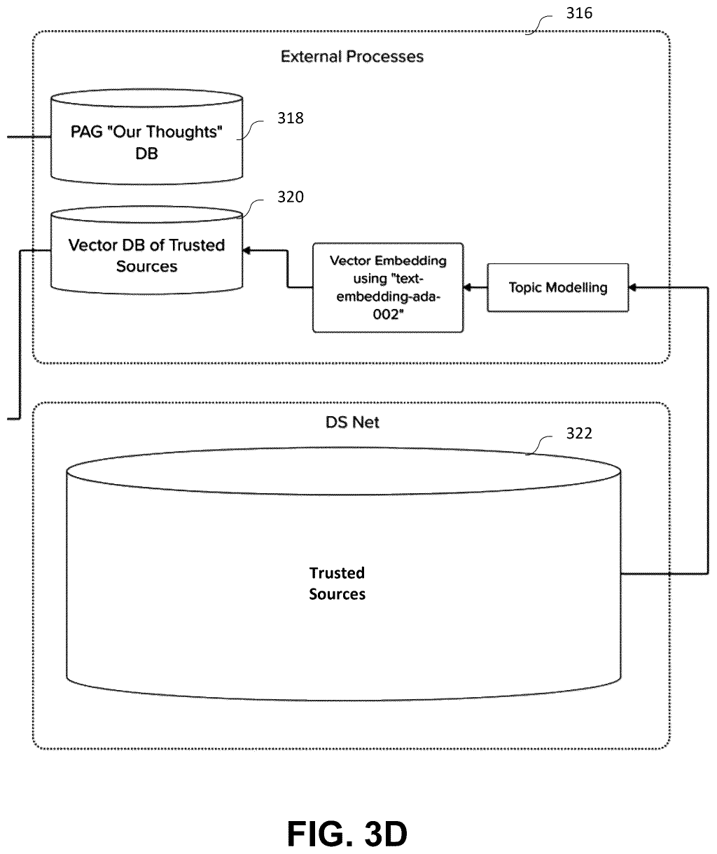

FIGS. 3A-D are schematic diagrams showing a functional architecture of the computer network system shown in FIG. 1, according to some embodiments of this disclosure.

The computer network system 100 comprises a plurality of modules including a user-interface (UI) module in the form of a browser extension or plug-in such as a Google Chrome extension, (see FIG. 3A) for interacting with users, and a backend module for performing trust analysis (see FIGS. 3B and 3C), which interacts with external processes/databases (see FIG. 3D). Each of these module comprises one or more services, as described in more detail below.

Herein, a service is a function block exposing some application programming interfaces (APIs) and containing some business logic, and may be independently deployed and dockerized. Herein, a “module” is a term of explanation referring to a hardware structure such as a circuitry implemented using technologies such as electrical and/or optical technologies (and with more specific examples of semiconductors) for performing defined operations or processings. A “module” may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer-readable storage devices or media.

As a part of a device, an apparatus, a system, and/or the like, a module may be coupled to or integrated with other parts of the device, apparatus, or system such that the combination thereof forms the device, apparatus, or system. Alternatively, the module may be implemented as a standalone device or apparatus.

Referring to FIG. 3A, the UI module may comprise an article-scraping service 302 for collecting/obtaining one or more articles for trust analysis, and a frontend service 304 for interacting with users. The frontend service 304 may display data to users based on the trust analysis results, and may for example provide a summary of the analyzed article, provide relevant articles and/or opinions from one or more trusted sources, provide a content reliability score, etc., and may also provide a means for receiving user feedback (such as via a pop-up displayed in the UI), and/or the like.

Referring to FIGS. 3B and 3C, the backend module comprises an information-gathering service 306 that communicates with the frontend service 304, a contextually-trained artificial intelligence (AI) trust analysis model 308 such as a machine learning (ML) trust analysis model, an article cache 310 storing information related to the article, and an article processing service 312.

When receiving an article from the article scraping service 302, the article processing service 312 analyzes the article and determines various information about the article to determine one or more trust factors for use in evaluating the reliability of the content in the article. For example, the article processing service 312 may process the article to identify key topics (such as sector that the article pertains to, a security mentioned in the article, key takeaways from the article, etc.), to identify facts claimed in the article, to identify a relevant stock ticker associated with a security mentioned in the article, to identify relevant articles from trusted sources, to identify emotional/sensational words used in the article, to identify a readability level of the article and/or number of sources referenced in the article, and/or to determine/track article traffic based on user visits to the article.

The article processing service 312 may perform topic modeling 314 using an AI model to identify the key topic(s) and facts claimed in the article.

The article processing service 312 may also communicate with external processes 316 shown in FIG. 3D, such as to access a database 318 storing opinions or thoughts on a subject from a Thought Leader relevant to the subject in the article (which may comprise, for example, opinions on stocks or sectors provided by a Portfolio Advisory Group (PAG) of a reputable bank) to retrieve relevant notes therefrom.

The article processing service 312 may also communicate with the external processes 316 to search trusted content sites such as by accessing a vector database 320 of key facts from trusted sources, and/or the like. The external processes 316 may generate the vector database 320 by accessing a data acquisition system DS Net to retrieve data from one or more trusted sources stored in a trusted sources database 322, determine key topics and/or facts claimed in the articles from the trusted sources database by performing topic modelling, and generating vector embeddings of the key topics and/or facts for storage in the vector database 320 using an embedding model to create embeddings where input text is converted into vector representation using a pre-trained model. Generating vector embeddings of the topics and/or facts claimed in the trusted sources enables a simpler comparison of facts claimed in the article being evaluated. The article processing service 312 can thus identify relevant articles (e.g. based on topic(s)) and compare facts claimed in the article against the facts claimed in relevant articles from the trusted sources.

To identify emotional/sensational words used in the article, the article processing service 312 may use an emotion lexicon 324. The article processing service 312 may classify each word in the article using the emotional lexicon 324, and calculate a percentage of positive, negative, and/or emotional language in the article . . .

The article processing service 312 may identify readability level of the article, number of sources of the article, and/or the like, using a further AI model (such as using OpenAI's API (model: gpt-4-turbo)).

The information/trust factors determined by the article processing service 312 is/are sent to the contextually-trained artificial intelligence (AI) trust analysis model 308 for analysis. The contextually-trained trust analysis artificial intelligence (AI) model calculates a trust metric, such as a content reliability score for the article based on the information/trust factors.

In addition, the information determined/trust factors determined by the article processing service 312 may be stored in the article cache 310. The article cache 310 may also store user reviews of the reliability of the article which are received via the frontend service 304 from users viewing the article. The information stored in the article cache 310 may be used for intermediary training of the contextually-trained artificial intelligence (AI) trust analysis model 308, thus allowing for continuous model training and/or augmentation of the model 308.

The information-gathering service 306 receives/gathers the trust metric/content reliability score output from the contextually-trained AI trust analysis model 308, and optionally information from the article cache 310, for output to the frontend service 304. For example, based on the information stored in the article cache 310, the information-gathering service may generate/output information in addition to the content reliability score such as a summary of the article, relevant articles and/or opinions from trusted sources, user feedback, and/or the like, which is provided to the frontend service 304.

Accordingly, in various embodiments, the computer architecture can perform a trust analysis method that provides at least some of the following functionalities:

Summarizing the article:
the trust analysis method may use OpenAI API (for example, model: gpt-4-turbo) to extract article semantics such as facts claimed, key takeaways, and/or the like;
the trust analysis method may use OpenAI API (for example, model: gpt-4-turbo) to extract article qualities such as sector, securities, author, and/or the like.

Collecting user feedback
the trust analysis method may collect article traffic of the article by tracking how many users have visited a website;
the trust analysis method may allow users to provide a review on the article, such as via a small pop-up dialog wherein the users may choose between the article being safe or questionable. Such user feedback provides data labelling which enables model training and allows the system 100 to alert future website visitors that their colleague has found the article safe or questionable.

Relevant articles and/or opinions from trusted sources:
semantic search may be performed on articles from the trusted sources such as the sources listed below. Articles from the trusted sources are summarized, their claims are then vectorized and embedded into a Chroma Vector DB (or other suitable database offering vector embedding) along with links to the corresponding article, allowing for semantic search of claims. Examples of trusted sources include:
   RBC CM Research
   JP Morgan Research
   Morningstar Research
   Veritas Research
   Value Line Research
   Fund Strat Research
In addition to the articles from trusted sources, the system 100 may also collect a relevant opinion from a thought leader within a trusted organization. For example, if an advisor in Wealth Management of a reputable bank is reading an article about a company, then the system 100 may display the most recent opinion from an advisory group of the trusted organization.

Content reliability:
the amount of emotional and/or sensational words may be calculated by classifying each word in the article using the emotional lexicon, and the percentage of positive/negative or emotional language present in the article is calculated. In some embodiments, targeted sentiment analysis may be performed on the topics mentioned in the article.
the readability level of the article may be evaluated using, for example, OpenAI's API (such as model: gpt-4-turbo). In some embodiments, a model specifically trained on evaluating readability may be used.
a contextually-trained trust analysis AI model, which may be a ML model (such as a feedforward neural network (FNN)), is trained in determining a trust metric such as a content reliability score indicative of whether content in the is reliable/safe vs. unreliable/questionable based on the features explained and gathered above. The system 100 provides the result to a user viewing the article in the user interface of the user device, such as in a small pop-up window in the top corner of their display screen. Further, as data is collected and labelled through the user feedback features, the AI/ML model may be retrained/augmented to continuously improve.

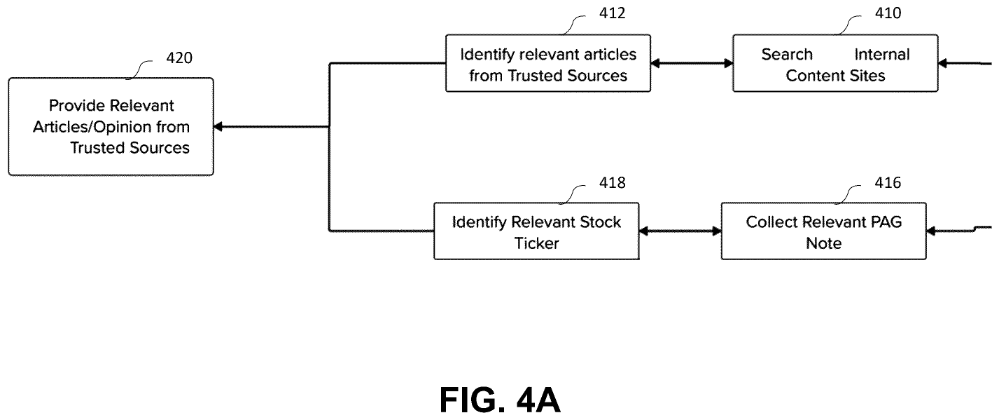

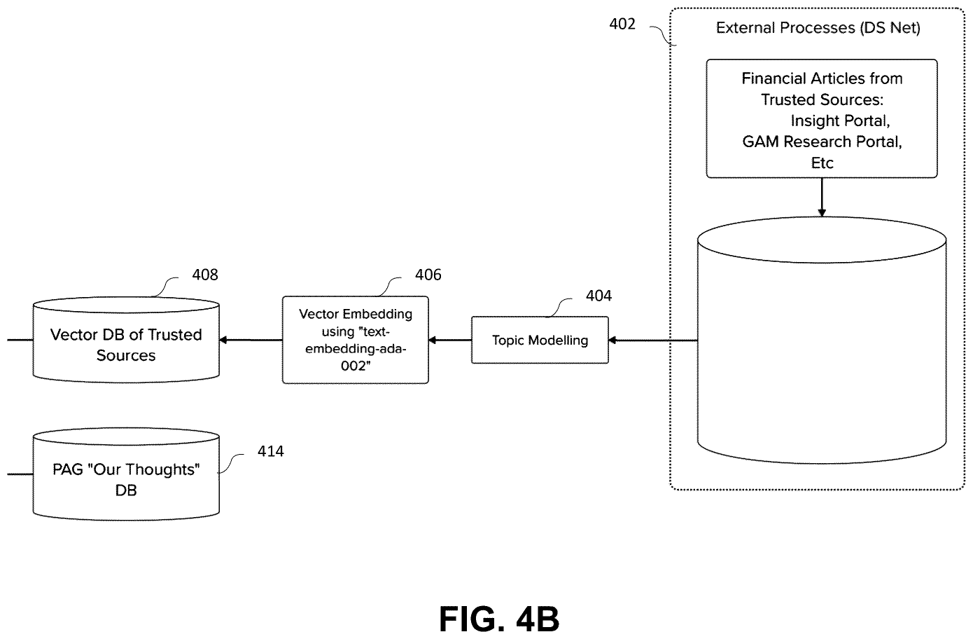

FIGS. 4A and 4B are flowcharts showing a trusted sources semantic search method performed by the computer network system shown in FIG. 1, according to some embodiments of this disclosure. As described above, the system/method may be configured to determine relevant articles and/or opinions from trusted sources that are relevant to the article being viewed by a user, which can be used for fact claim verification and/or for output as supplemental information to the user.

With reference to FIGS. 4A and 4B, external processes may be executed (402) to store articles (in this example, financial articles) from one or more trusted sources in a database. Topic modelling is performed (404) to determine key topics and/or facts claimed in the articles from the trusted sources database, and a vector embedding of the key topics and/or facts is generated (406) and stored in a vector database (408). The vector database may be searched (410) to thereby search internal/trusted content sites and identify relevant articles from trusted sources (412), which can be output (420) for use in determining a trust factor of the article and/or for display to a user.

Further, a database (414) storing opinions from thought leaders may be accessed to collect relevant notes (416) relevant to the article, such as based on a stock ticker identified in the article (418). The relevant notes from thought leaders can be output (420) for use in determining a trust factor of the article and/or for display to a user.

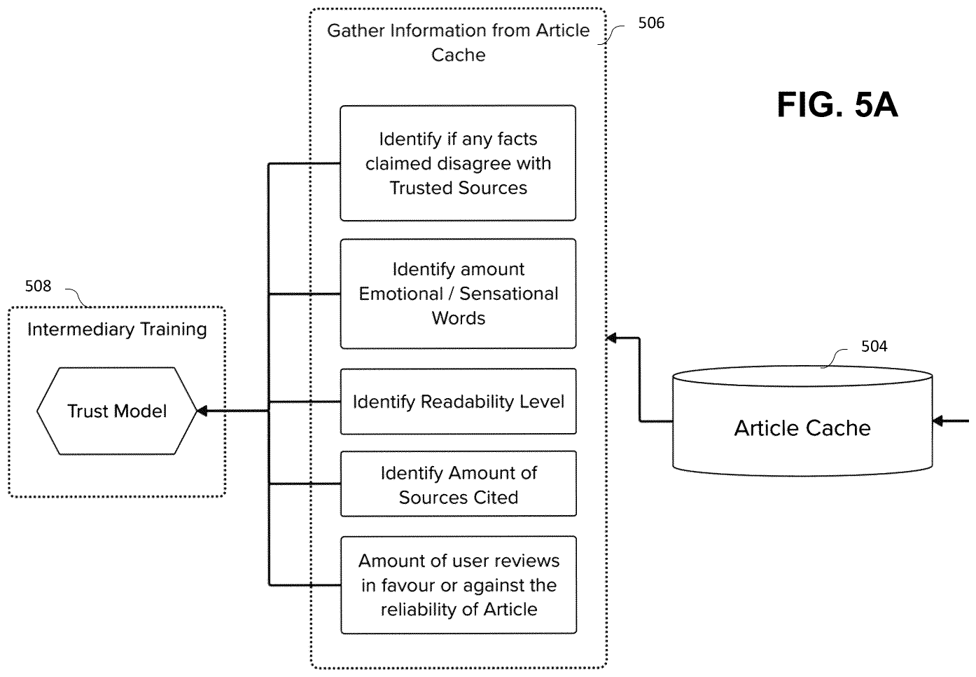

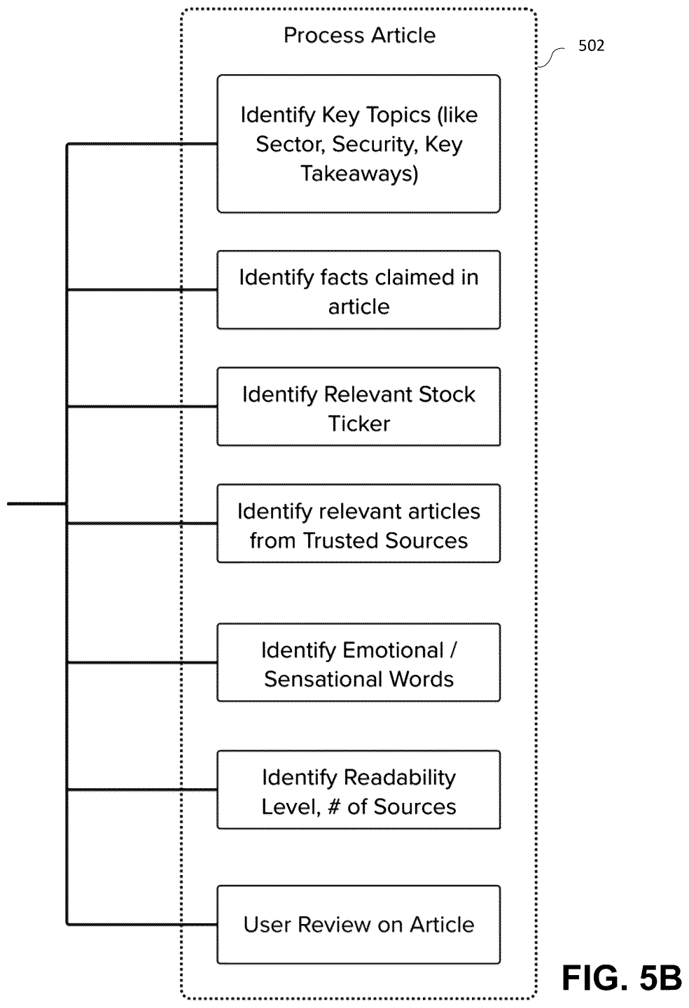

FIGS. 5A and 5B are flowcharts showing an intermediate model training method performed by the computer network system shown in FIG. 1, according to some embodiments of this disclosure. As described above, the contextually-trained artificial intelligence (AI) trust analysis model may undergo intermediary training based on information collected over time to allow for continuous model training and/or augmentation of the model.

With reference to FIGS. 5A and 5B, an article processing service 502 may generate and/or collect information, and may for example process a plurality of articles to respectively identify key topics (such as sector that the article pertains to, a security mentioned in the article, key takeaways from the article, etc.), to identify facts claimed in the article, to identify a relevant stock ticker associated with a security mentioned in the article, to identify relevant articles from trusted sources, to identify emotional/sensational words used in the article, to identify a readability level of the article and/or number of sources referenced in the article, to determine/track article traffic based on user visits to the article, and/or to determine/collect user reviews on an article. The information from the article processing service 502 is stored in an article cache 504. An intermediary model training service 506 gathers information from the article cache 504 for one or more processed articles to be used for the intermediary training, and determines information to be used for the intermediary model training, comprising one or more trust factors for a given article such as any facts claimed in the article that disagree with trusted sources, the amount of emotional/sensational words used in the article, the readability level of the article, an amount of sources cited in the article, and an amount of user reviews in favour or against the reliability of the article. Intermediary model is performed (508).

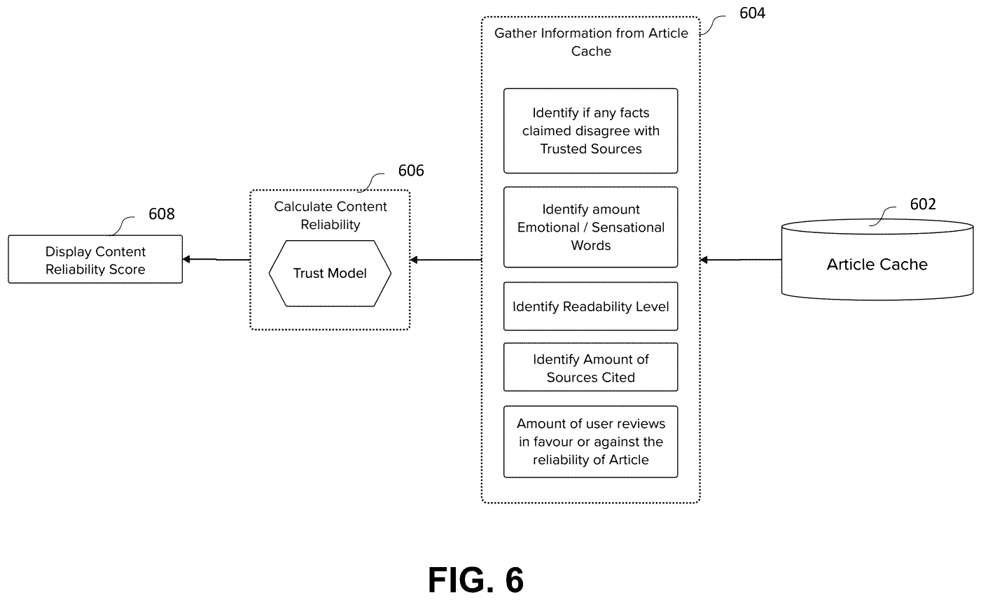

FIG. 6 is a flowchart showing a model inference method performed by the computer network system shown in FIG. 1, according to some embodiments of this disclosure. Information stored in an article cache 602 for a given article (e.g. based on information of the article generated using an article processing service) is gathered and used for determining one or more trust factors related to the article (604). The one or more trust factors for the article may comprise any facts claimed in the article that disagree with trusted sources, the amount of emotional/sensational words used in the article, the readability level of the article, an amount of sources cited in the article, and an amount of user reviews in favour or against the reliability of the article. The one or more trust factors are input to a contextually-trained trust analysis artificial intelligence (AI) model to determine a content reliability score of the article (606). The content reliability score is output for display on a user device (608).

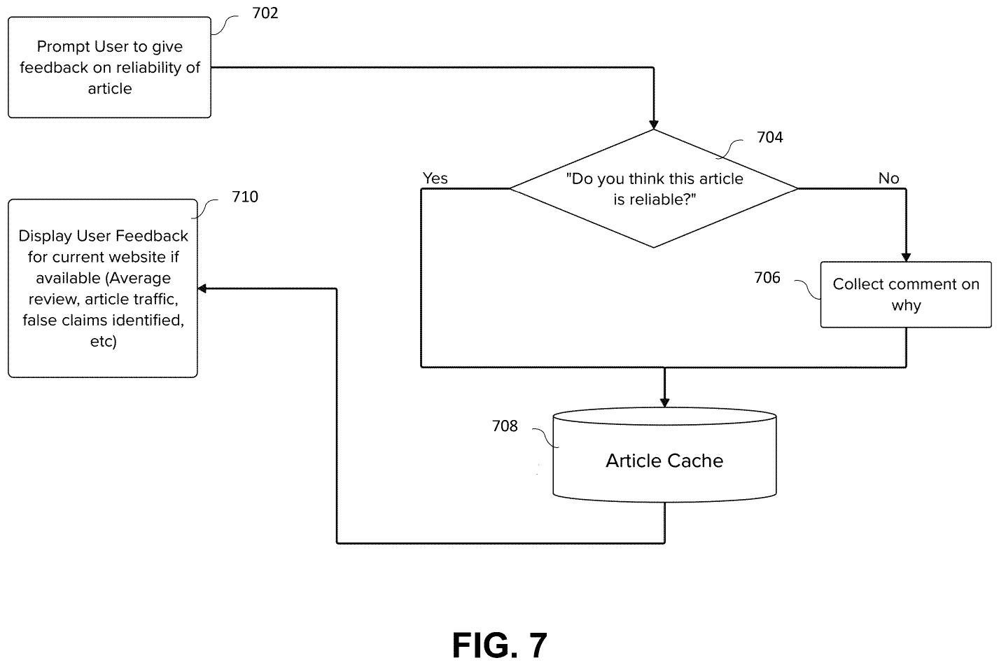

FIG. 7 is a flowchart showing a user feedback collection method performed by the computer network system shown in FIG. 1, according to some embodiments of this disclosure. A prompt is presented in the user interface asking the user to give feedback on the reliability of the article (702). The prompt may for example ask the question: do you think this article is reliable? If no, user may be prompted to comment on why they do not think the article is reliable (706), and the comment along with the user's answer may be stored in the article cache (708). If yes, the user's answer is stored in the article cache (708). User feedback for the current website/article may also be displayed in the user interface if available (710), for example presenting information on the average review, article traffic, false claims identified, etc.

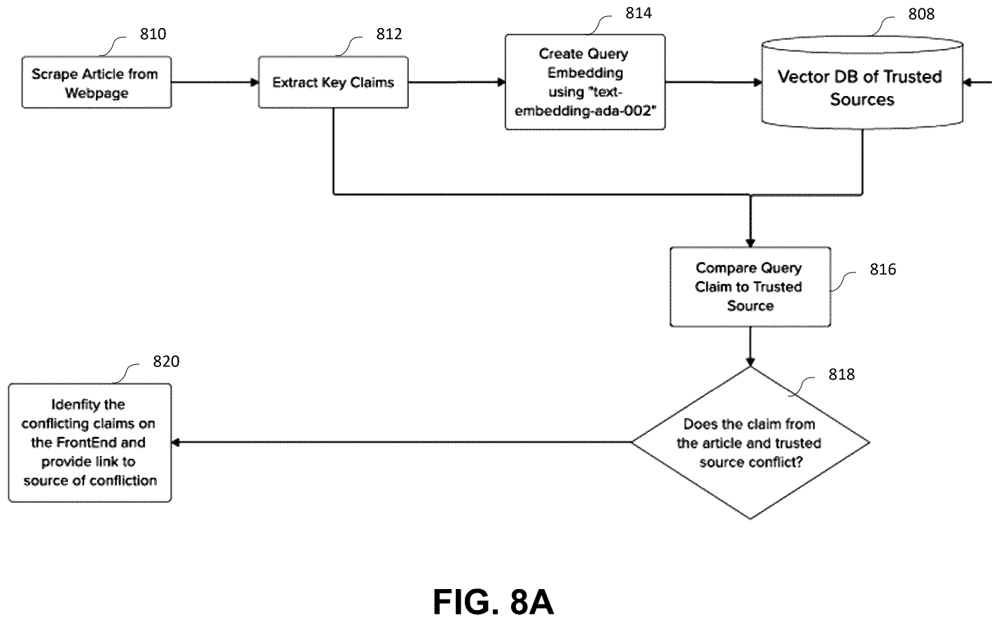

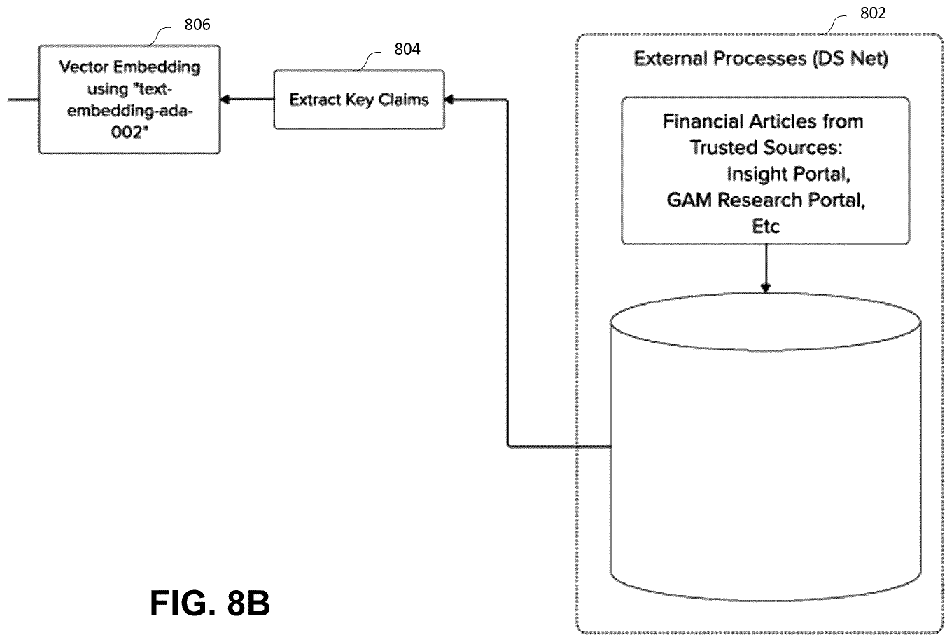

FIGS. 8A and 8B are flowcharts showing an automatic fact check method performed by the computer network system shown in FIG. 1, according to some embodiments of this disclosure.

With reference to FIGS. 8A and 8B, external processes may be executed (802) to process and store articles (in this example, financial articles) from one or more trusted sources in a database. Topic modelling is performed to extracts facts claimed in the articles (804) from the trusted sources database, and a vector embedding of the facts is generated (806) and stored in a vector database (808).

For an article that is being viewed by a user, the article is scraped from the webpage or otherwise obtained (810) and claims from the article are extracted (812). A vector embedding of the claims may be generated (814) and used for querying the vector database (808).

Accordingly, a comparison is made between the fact(s) claimed in the article and the facts claimed in the articles from the trusted sources (816). A determination is made as to whether any claim(s) from the article being viewed by the user conflict/differ with facts claimed in the trusted sources (818). An output based on the determination can be provided to the front-end (820), such as an indication of any claims that conflict, a source of the conflict with a link to the trusted source, etc.

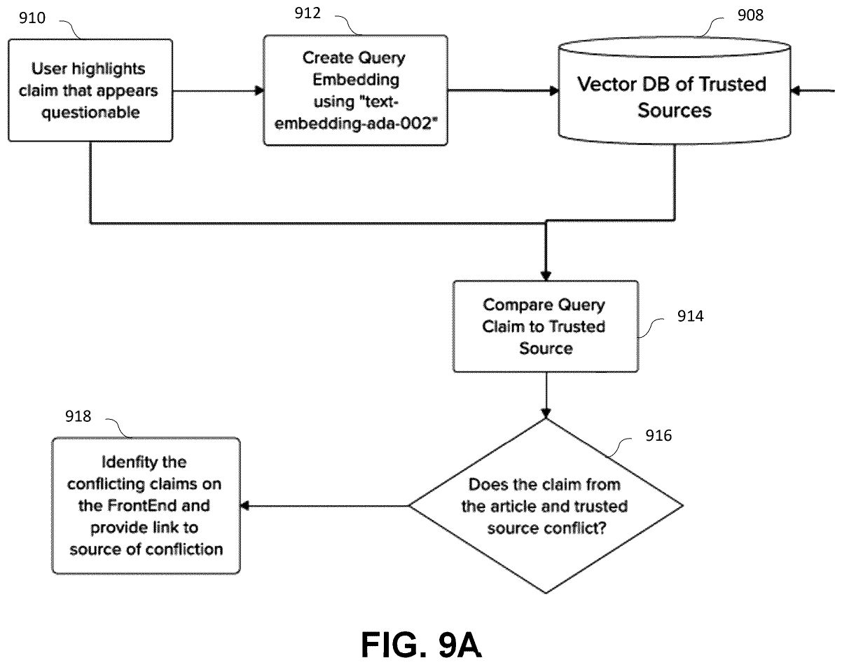

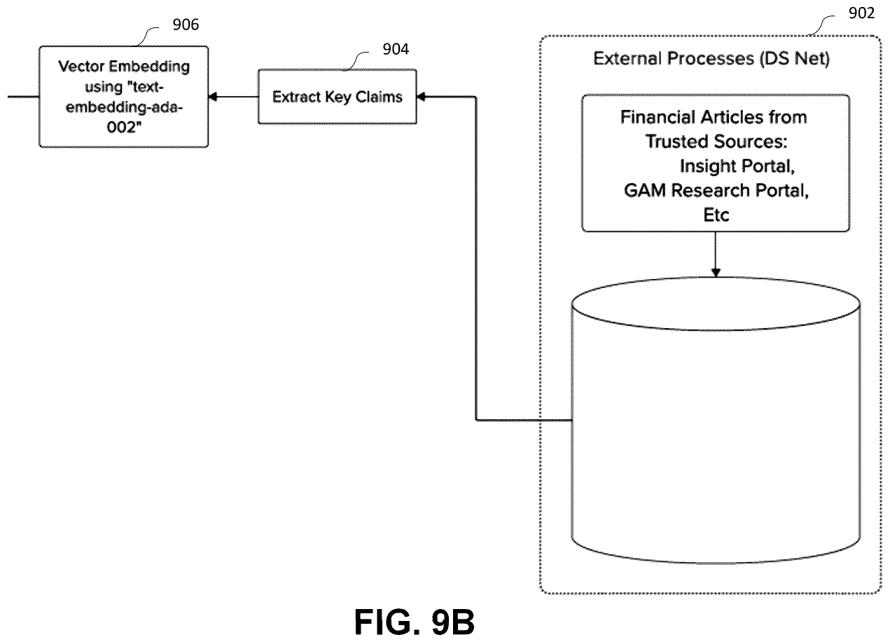

FIGS. 9A and 9B are flowcharts showing a manual fact check method performed by the computer network system shown in FIG. 1, according to some embodiments of this disclosure. The flowcharts shown in FIGS. 9A and 9B are similar to those shown in FIGS. 8A and 8B, however instead of automatically determining facts claimed in the article being viewed by the user and automatically comparing them to articles from trusted sources, the user highlights a claim made in the article for evaluation/fact-checking.

With reference to FIGS. 9A and 9B, external processes may be executed (902) to process and store articles (in this example, financial articles) from one or more trusted sources in a database. Topic modelling is performed to extracts facts claimed in the articles (904) from the trusted sources database, and a vector embedding of the facts is generated (906) and stored in a vector database (908).

For an article that is being viewed by a user, the user may highlight a claim made in the article for fact-checking (e.g. a claim that appears questionable) (910). A vector embedding of the claim may be generated (912) and used for querying the vector database (908).

Accordingly, a comparison is made between the fact claimed in the article highlighted by the user and the facts claimed in the articles from the trusted sources (914). A determination is made as to whether the claim from the article highlighted by the user conflicts/differs with facts claimed in the trusted sources (916). An output based on the determination can be provided to the front-end (918), such as an indication of any claims that conflict, a source of the conflict with a link to the trusted source, etc.

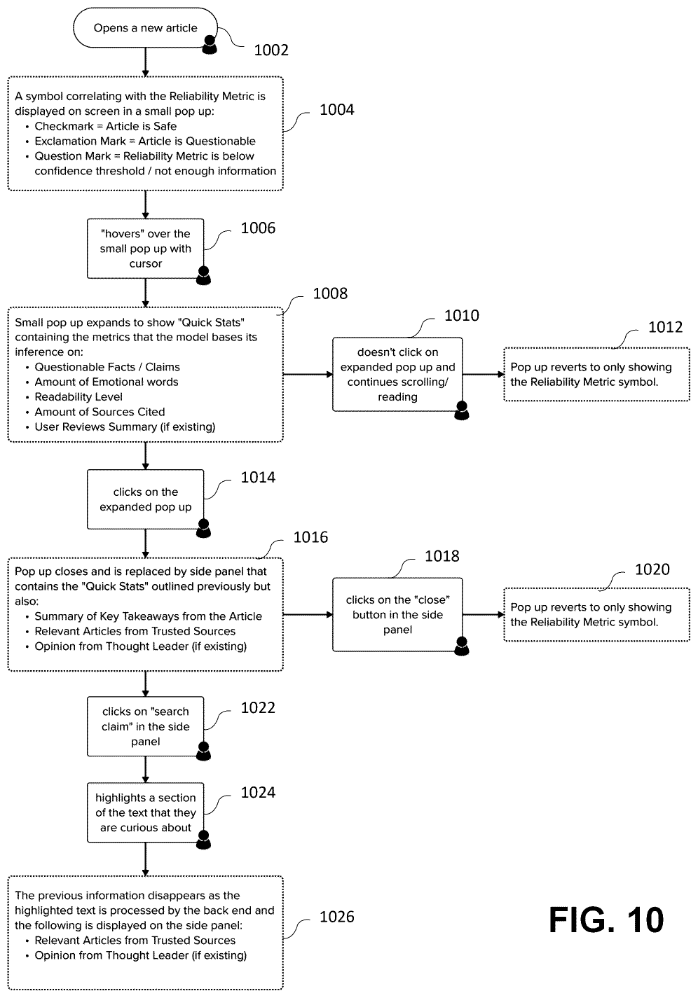

FIG. 10 shows a user flow diagram for the computer network system shown in FIG. 1, according to some embodiments of this disclosure.

A user opens a new article on their user device (1002), for example in a web browser. A symbol correlating with the content reliability metric is displayed in the user interface (1004), such as in a small pop-up on the screen. The symbol may for example be a checkmark if the article is safe/reliable, an exclamation mark if the article is questionable/unreliable, a question mark if the reliability metric is below a confidence threshold or if there is not enough information, etc.

The user may hover over the small pop-up with their cursor (1006), and the pop-up may for example expand to show quick statistics containing information about the article, such as the metrics/trust factors that the model based its inference on (1008). For example, the quick statistics may display metrics such as questionable facts/claims, amount of emotional words, a readability level, an amount of sources cited, a summary of user reviews (if existing), etc.

If the user doesn't click on the expanded pop-up and continues scrolling/reading the article (1010), the pop-up may revert to showing only the reliability metric symbol (1012).

However, if the user clicks on the expanded pop-up (1014), the pop-up may close and be replaced by a larger side panel (1016), which may contain the quick statistics mentioned above and additional information, such as a summary of key takeaways from the article, relevant articles from trusted sources, and/or opinions from thought leaders (if existing), etc.

If the user clicks on the close button in the side panel (1018), the pop-up reverts to only showing the reliability metric symbol (1020).

However, the user may click on other functionality within the side panel, such as a search claim functionality (1022), in which case the user may highlight a section of the text that they are curious about (1024), and in response the previous information in the side panel may disappear as the highlighted text is processed by the back-end, and the side panel displays information in response to the search claim 1026), such as relevant articles from trusted sources, opinions from thought leaders (if existing), etc.

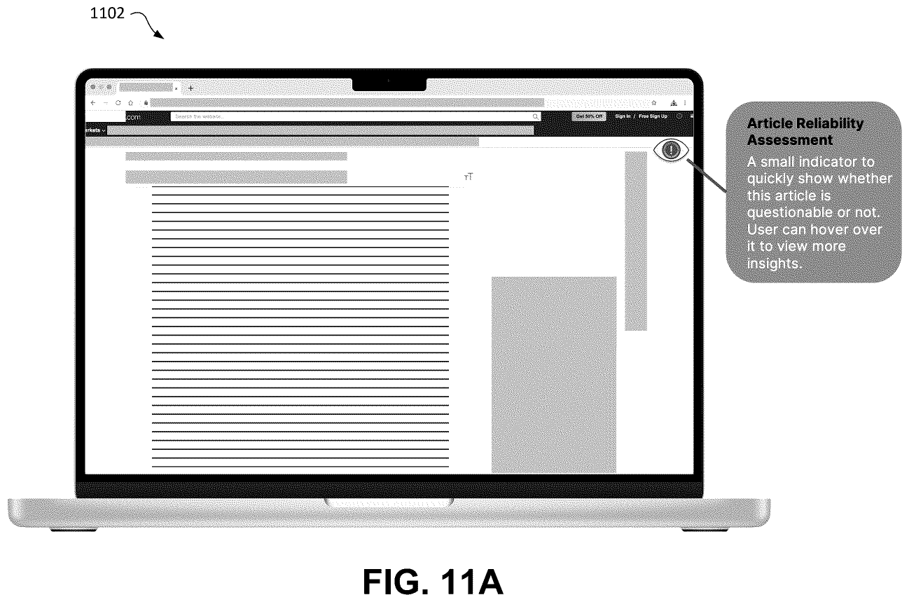

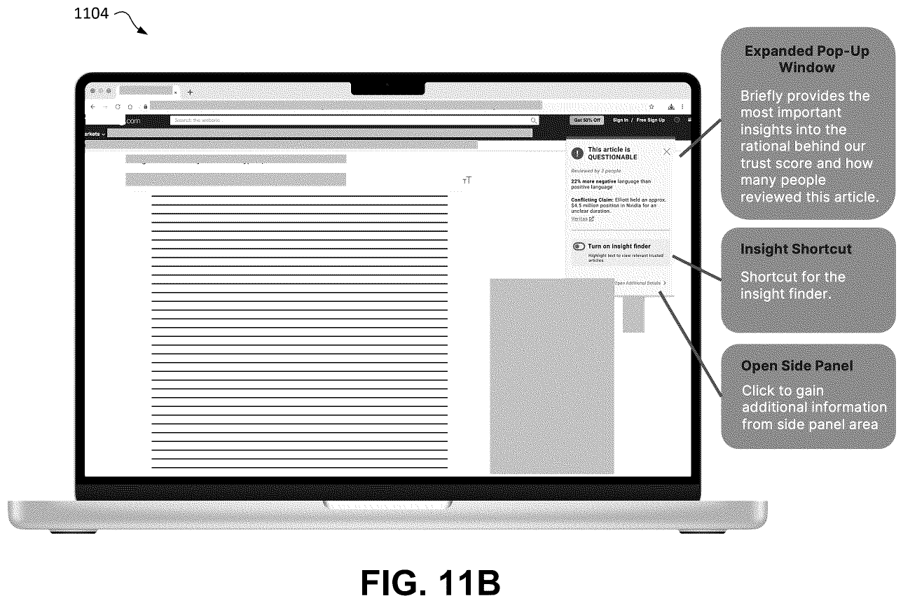

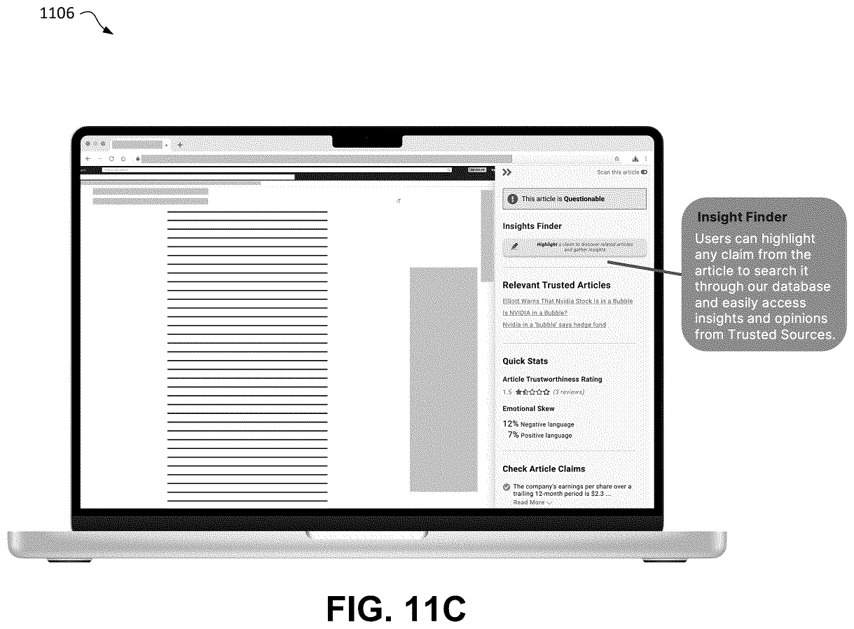

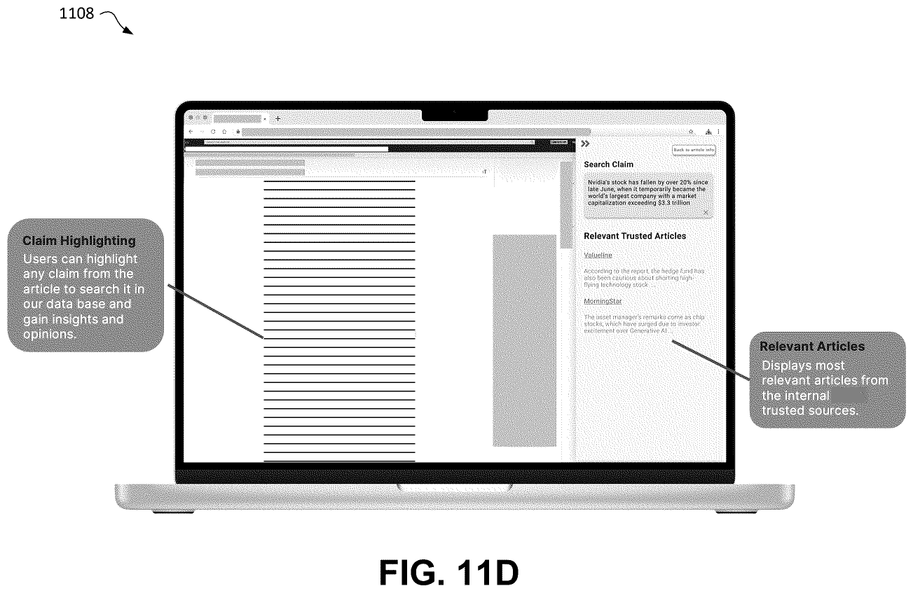

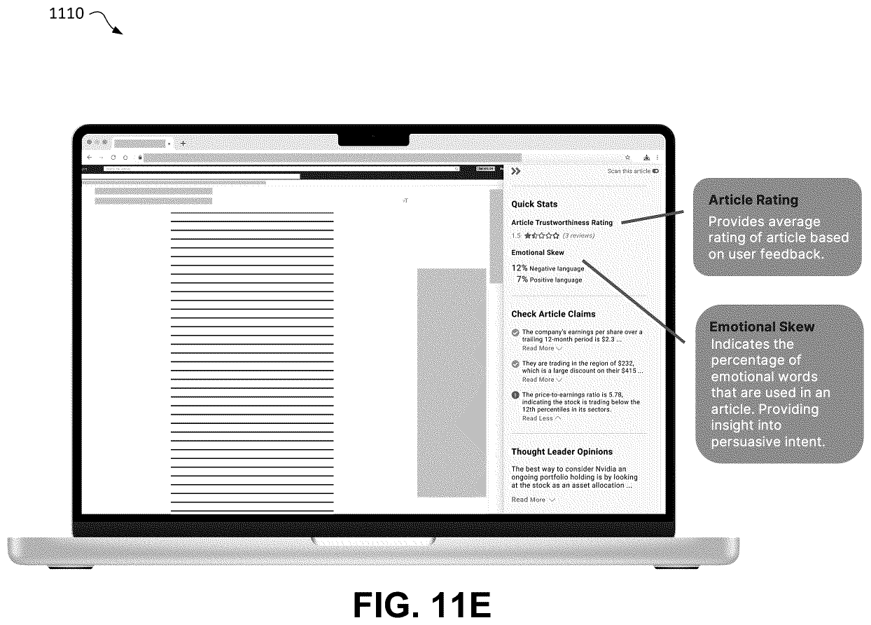

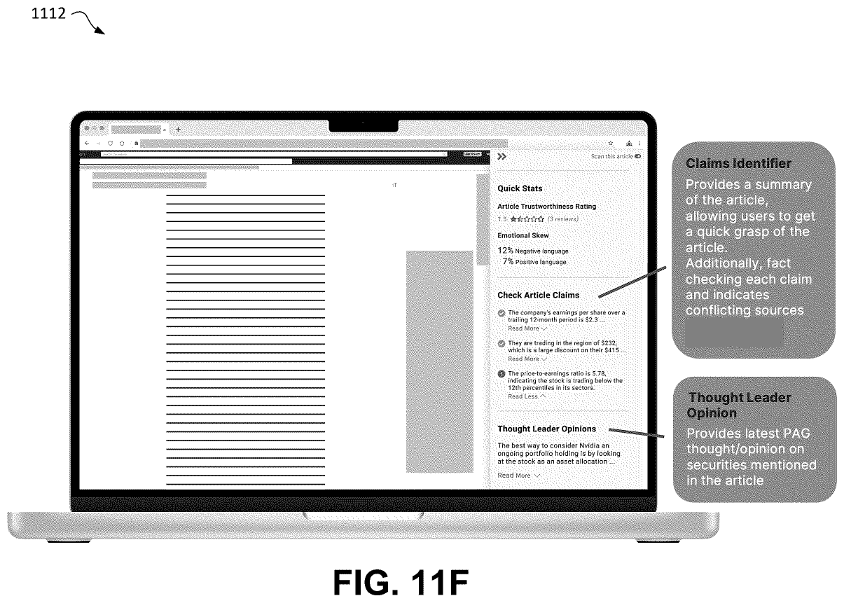

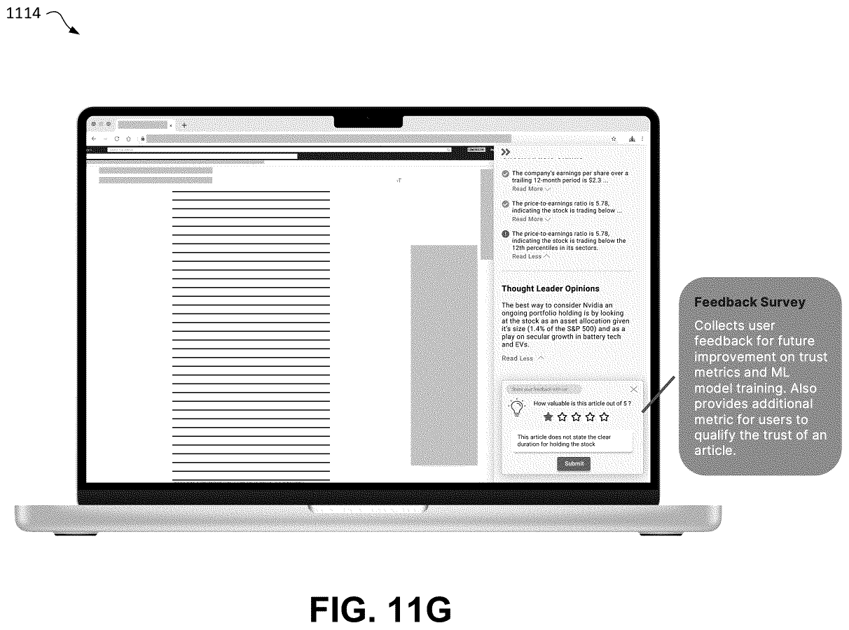

FIGS. 11A to 11G are sample UIs a user may experience when the computer network system 100 performs the trust analysis, according to some embodiments of this disclosure, wherein FIG. 11A is a UI 1102 showing an article reliability assessment (in this case, an exclamation mark indicating that the article is questionable) of an article using the trust analysis method disclosed herein. FIG. 11B is a UI 1104 showing a popup window after the assessment of the article, warning that the article is questionable. FIGS. 11C and 11D are UIs 1106 and 1108 showing an insight finder using the trust analysis method disclosed herein, wherein users can highlight any claim from the article to search it through a database for insights and opinions from trusted sources. FIG. 11E is a UI 1110 showing a quick statistics screen displaying a brief result of the assessment such as article rating, emotional skew, assessments of article claims, and/or the like. FIG. 11F is a UI 1112 showing a panel comprising information of a claims identifier displaying the article claims, and thought leader opinions. FIG. 11G is a UI 1114 showing user/community feedback in the form of a rating given to the article.

In some embodiments, the trust analysis system/method may further comprise a deepfake detection function, which identifies manipulated audio, video, or images to prevent the spread of misinformation. The trust analysis method may use any suitable deep learning models such as Xception (for images/videos) WaveNet (for audio), and/or the like, trained on datasets of real and fake media, to classify the authenticity of media content.

In some embodiments, the trust analysis system/method may comprise a targeted sentiment analysis function to analyze the emotional tone of the text for specific objects mentioned therein, such as: “This company's share price continues to rise despite the low performance of their main product”, wherein this company may be in a positive tone, and their main product may be in a negative tone. More specifically, a pre-trained model such as BERT or ROBERTa fine-tuned for sentiment analysis may be used, which can process input text and output sentiment scores.

In some embodiments, the trust analysis system/method may comprise a contextual media verification function, which ensures that media is used in the correct context and not misleadingly. More specifically, the system extracts metadata from media files and performs reverse image/video search using search engine APIs to compare with known instances and verify context.

In some embodiments, the trust analysis system/method may comprise a claim verification function, which cross-checks claims made in the article against a database of verified information. More specifically, natural language processing (NLP) may be used to extract claims from text and compare them against a fact-checking database using APIs from fact-checking organizations.

In some embodiments, the trust analysis system/method may use data clustering, which assigns labels to trusted articles for company, sector, stance, author, time, and/or the like. Once labels are assigned, they can be used to filter the results of the semantic search function, thereby allowing users to refine searches to articles on certain companies, by certain authors, and/or the like.

In some embodiments, the trust analysis system/method may comprise an author credibility module for assessing the reliability of the author based on historical data. More specifically, the trust analysis method maintains a database of author credibility scores derived from past articles and performance metrics, and updates with new data using machine learning models.

In some embodiments, the trust analysis system/method may comprise a source credibility module, which evaluates the trustworthiness of the publication source. More specifically, the trust analysis method aggregates historical performance data of publications, and calculates credibility scores based on metrics such as accuracy and bias, and adherence to journalistic standards.

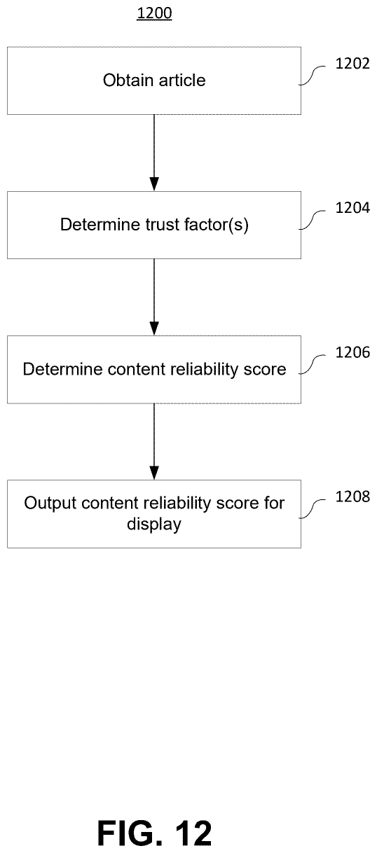

FIG. 12 shows a computerized method 1200 for performing trust analysis of online media, in accordance with embodiments of the present disclosure. The computerized method 1200 may be implemented by the computer network system 100 as described herein. One or more non-transitory computer-readable storage media may comprise computer-executable instructions stored thereon, which, when executed, cause one or more processors to perform the computerized method 1200.

The method 1200 comprises obtaining an article that a user is viewing on a user device (1202), analyzing the article to determine one or more trust factors related to the article (1204), determining a content reliability score of the article using a contextually-trained trust analysis artificial intelligence (AI) model based on the one or more trust factors (1206); and outputting the content reliability score of the article for display in a user interface of the user device (1208). Additionally, information related to the one or more trust factors may also be output and displayed in the user interface.

In embodiments, the user may view the article in a web browser on the user device, and an application programming interface (API) obtains the article via a web browser extension running on the user device. Accordingly, the content reliability score is output from the API to the web browser extension that displays the content reliability score in the web browser.

The one or more trust factors related to the article may comprise one or more of: an indication of whether any facts claimed in the article disagree with trusted sources; an amount of emotional and/or sensational words used in the article; a readability level of the article; a number of sources cited in the article; and an amount of user reviews in favour or against the reliability of the article.

The indication of whether any facts claimed in the article disagree with trusted sources may be determined by: using one or more AI models to determine a topic of the article; using the one or more AI models to determine facts claimed in the article; determining one or more relevant articles from one or more trusted sources based on the topic of the article; and comparing the facts claimed in the article with facts claimed in the one or more relevant articles to determine whether any facts claimed in the article disagree with the trusted sources. The method may further comprise generating a vector database comprising facts claimed in articles from the one or more trusted sources, and wherein the vector database is accessed for comparing the facts claimed in the article with the facts claimed in the one or more relevant articles.

The amount of emotional and/or sensational words used in the article may be determined by classifying each word in the article using an emotional lexicon, and calculating a percentage of positive, negative, and/or emotional language in the article.

The readability level of the article may be determined using a further AI model.

The user reviews may be received via the user interface. A user review of the reliability of the article may be received via the user interface from the user viewing the article, and the method may further comprise performing continuous model training and/or augmentation based on the user review.

As those skilled in the art readily understand, a computer system or a computing device is of limited or even no use if it is not tied to a practical application and/or if it cannot provide sufficient functioning in that practical application. In other words, the usefulness and functioning of a computer system or a computing device needs to be measured in the context of a practical application that the computer system or a computing device is applied therein.

As can be seen from the above description, the systems, methods, and non-transitory computer-readable storage devices for trust analysis are clearly integrated with the computer system for analyzing an article that a user is viewing on a user device and determining a content reliability score of the article for display to the user. For example, the user may be viewing the article in a web browser on the user device, the article is received at an application programming interface (API) via a web browser extension running on the user device, and the content reliability score is output from the API to the web browser extension that displays the content reliability score in the web browser. The systems, methods, and non-transitory computer-readable storage devices for trust analysis thus provide an automated solution for evaluating a reliability/trustworthiness of articles, and can be directly integrated into a web browser, facilitating integration with the user computing devices and prompting users to take caution when an article's reliability is questionable.

Further, with the use of AI engines such as ML engines, the computer systems, computing devices, and computerized methods disclosed herein can analyze articles and determine a content reliability score of the article using a contextually-trained trust analysis artificial intelligence (AI) model based on a variety of trust factors, and can incorporate user feedback for continuous model training and/or augmentation to provide improved results.

Thus, the computer systems, computing devices, and computerized methods disclosed herein are integrated into a practical application of trust analysis of online media with improvement to the functioning of the computer systems and computers thereof in this practical application, thereby rendering the computer systems and computing devices thereof more useful in this practical application. With the use of AI engines such as ML engines, computing devices are required for the system to perform the method disclosed herein.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A computerized method, comprising:
obtaining an article that a user is viewing on a user device;
analyzing the article to determine one or more trust factors related to the article;
determining a content reliability score of the article using a contextually-trained trust analysis artificial intelligence (AI) model based on the one or more trust factors; and
outputting the content reliability score of the article for display in a user interface of the user device.

2. The computerized method of claim 1, wherein the user is viewing the article in a web browser on the user device, wherein an application programming interface (API) obtains the article via a web browser extension running on the user device, and wherein the content reliability score is output from the API to the web browser extension that displays the content reliability score in the web browser.

3. The computerized method of claim 1, wherein the one or more trust factors related to the article comprise one or more of:
an indication of whether any facts claimed in the article disagree with trusted sources;
an amount of emotional and/or sensational words used in the article;
a readability level of the article;
a number of sources cited in the article; and
an amount of user reviews in favour or against the reliability of the article.

4. The computerized method of claim 3, wherein the indication of whether any facts claimed in the article disagree with trusted sources is determined by:
using one or more AI models to determine a topic of the article;
using the one or more AI models to determine facts claimed in the article;
determining one or more relevant articles from one or more trusted sources based on the topic of the article; and
comparing the facts claimed in the article with facts claimed in the one or more relevant articles to determine whether any facts claimed in the article disagree with the trusted sources.

5. The computerized method of claim 4, further comprising generating a vector database comprising facts claimed in articles from the one or more trusted sources, and wherein the vector database is accessed for comparing the facts claimed in the article with the facts claimed in the one or more relevant articles.

6. The computerized method of claim 3, wherein the amount of emotional and/or sensational words used in the article is determined by classifying each word in the article using an emotional lexicon, and calculating a percentage of positive, negative, and/or emotional language in the article.

7. The computerized method of claim 3, wherein the readability level of the article is determined using a further AI model.

8. The computerized method of claim 3, wherein the user reviews are received via the user interface.

9. The computerized method of claim 1, further comprising outputting information related to the one or more trust factors in the user interface.

10. The computerized method of claim 1, further comprising receiving a user review of the reliability of the article via the user interface from the user viewing the article, and performing continuous model training and/or augmentation based on the user review.

11. A system, comprising:
one or more processors; and
one or more non-transitory computer-readable storage media functionally coupled to the one or more processors, wherein the or more non-transitory computer-readable storage media comprise computer-executable instructions, which, when executed, cause the system to perform a computerized method comprising:
obtaining an article that a user is viewing on a user device;
analyzing the article to determine one or more trust factors related to the article;
determining a content reliability score of the article using a contextually-trained trust analysis artificial intelligence (AI) model based on the one or more trust factors; and
outputting the content reliability score of the article for display in a user interface of the user device.

12. The system of claim 11, wherein the user is viewing the article in a web browser on the user device, wherein an application programming interface (API) obtains the article via a web browser extension running on the user device, and wherein the content reliability score is output from the API to the web browser extension that displays the content reliability score in the web browser.

13. The system of claim 11, wherein the one or more trust factors related to the article comprise one or more of:
an indication of whether any facts claimed in the article disagree with trusted sources;
an amount of emotional and/or sensational words used in the article;
a readability level of the article;
a number of sources cited in the article; and
an amount of user reviews in favour or against the reliability of the article.

14. The system of claim 13, wherein the indication of whether any facts claimed in the article disagree with trusted sources is determined by:
using one or more AI models to determine a topic of the article;
using the one or more AI models to determine facts claimed in the article;
determining one or more relevant articles from one or more trusted sources based on the topic of the article; and
comparing the facts claimed in the article with facts claimed in the one or more relevant articles to determine whether any facts claimed in the article disagree with the trusted sources.

15. The system of claim 14, further comprising a vector database comprising facts claimed in articles from the one or more trusted sources, and wherein the vector database is accessed for comparing the facts claimed in the article with the facts claimed in the one or more relevant articles.

16. The system of claim 13, wherein the amount of emotional and/or sensational words used in the article is determined by classifying each word in the article using an emotional lexicon, and calculating a percentage of positive, negative, and/or emotional language in the article.

17. The system of claim 13, wherein the readability level of the article is determined using a further AI model.

18. The system of claim 13, wherein the user reviews are received via the user interface.

19. The system of claim 11, wherein the system is further configured to output information related to the one or more trust factors in the user interface.

20. The system of claim 11, wherein the system is further configured to receive a user review of the reliability of the article via the user interface from the user viewing the article, and performing continuous model training and/or augmentation based on the user review.
